(19) United States
(12) Patent Application Publication
(10) Pub. No.: US 2003/0233530 A1
(43) Pub. Date: Dec. 18, 2003

(54) Enhanced instruction prefetch engine

(75) Inventors: Richard Harold Boivie, Monroe, CT (US); Jun Tung Fong, Pleasantville, NY (US)

Correspondence Address: Michael J. Buchenhorner, 1430 Sorolla Avenue, Coral Gables, FL, 33134, US

(73) Assignee: International Business Machines Corporation, Armonk, NY

(21) Appl. No.: 10/172,335

(22) Filed: Jun. 14, 2002

(51) Int. Cl. G06F 9/00

(52) U.S. Cl. 712/207; 712/237

(57) ABSTRACT

A system and method for prefetching instructions from a slower memory for storing them in a faster memory includes the following: prefetching the instructions from a slower memory; recognizing an opcode corresponding to an unconditional branch instruction; continuing to prefetch at a target address of the unconditional branch instruction, responsive to recognizing the opcode corresponding to the unconditional branch instruction; recognizing an opcode corresponding to a conditional branch instruction; prefetching along each of the possible branches for the conditional branch instruction, responsive to recognizing the opcode corresponding to the conditional branch instruction; taking a branch from the possible branches of the conditional branch; and canceling prefetching of other possible branches not taken.

### BACKGROUND

1. Field of the Invention

This invention relates generally to information processing systems, and more specifically to an information processing system comprising an instruction prefetch engine for prefetching instructions from slow memory to reduce or eliminate execution delays associated with memory latencies particularly when branch instructions are executed.

2. Description of the Related Art

Improving processor performance is a continuing goal in the information processing industry. As we get closer to the limits of Moore's Law architectural approaches to speeding up processor speed become more desirable. One such approach is prefetching of instructions from a slow memory or storage device to a faster memory to improve system performance. It is also known in processor instruction execution, to predict the outcome of a branch instruction so that the instructions following the branch may be prefetched in parallel with the execution of the currently executing instructions. Prefetching is effective because processor speeds presently are faster than memory speeds. If the prefetch engine guesses (or predicts) the wrong branch, additional cycles will be required to fetch the required instructions on the correct branch. Therefore, there is a performance penalty when the branch prediction is incorrect. There is thus a need for a strategy that minimizes or eliminates these branch prediction performance penalties.

### SUMMARY OF THE INVENTION

Briefly according to the invention, a method for prefetching instructions from a slower memory for storing them in a faster memory comprises the following: prefetching the instructions from a slower memory; recognizing an opcode corresponding to an unconditional branch instruction; continuing to prefetch at a target address of the unconditional branch instruction, responsive to recognizing the opcode corresponding to the unconditional branch instruction; recognizing an opcode corresponding to a conditional branch instruction; prefetching along each of the possible branches for the conditional branch instruction, responsive to recognizing the opcode corresponding to the conditional branch instruction; selecting a branch for execution from the possible branches of the conditional branch; and canceling prefetching of other possible branches not selected.

### BRIEF DESCRIPTION OF THE DRAWINGS

FIG. 1 is a block diagram of a known information-processing system wherein the invention can be advantageously used.

FIG. 2 is a block diagram illustrating the operation of an instruction prefetch system according to the prior art.

FIG. 3 shows the system of FIG. 1 modified to operate according to an embodiment of the invention.

FIG. 4 illustrates the system operation when the execution unit gets to the conditional branch and takes one path or the other according to an embodiment of the invention.

FIG. 5 illustrates the system operation when the prefetch engine encounters a conditional branch when it is already prefetching along multiple paths, according to an embodiment of the invention.

FIG. 6 illustrates system operation when the execution unit reaches a conditional branch and takes one of the branches.

FIG. 7 is a flow chart illustrating the operation of an instruction prefetch system according to an embodiment of the invention.

### DETAILED DESCRIPTION

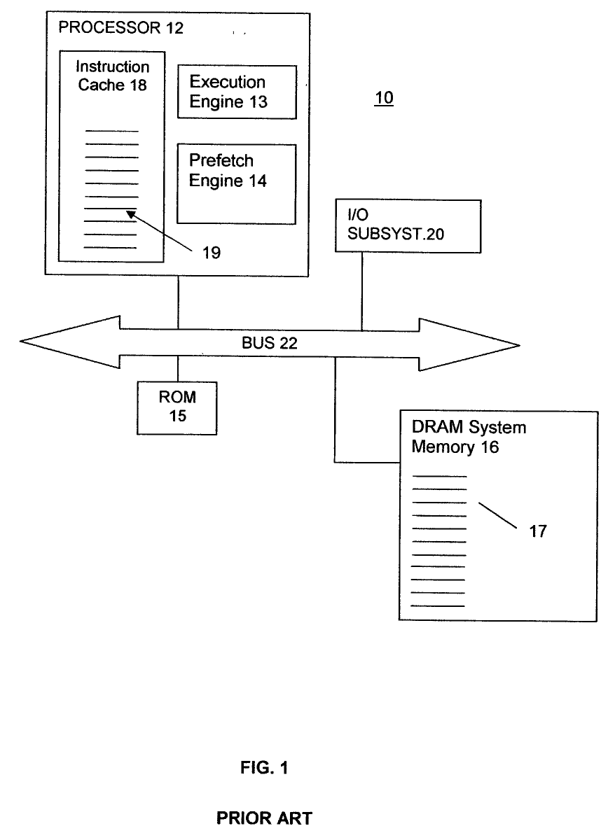

Referring to FIG. 1, there is shown a known information processing system 10 that can be modified to operate in accordance with an embodiment of the invention. The system 10 comprises a system processor 12, a system memory 16 (e.g., DRAM, or dynamic random-access memory), a read-only memory or ROM 15, and an I/O (input/output) subsystem 20, all coupled by means of a system bus 22. The processor includes an execution engine 13, a prefetch engine 14 that prefetches (or copies) instructions stored in the slower memory 16 and stores them in a faster memory (instruction cache 18) so that the execution engine 13 of the processor 12 does not have to wait for instructions to be fetched from the slower memory 16. The instructions copied into the instruction cache 18 may constitute an entire computer program or a portion thereof. The copied instructions 19 are a subset of the instructions 17 in DRAM 16. Although the instruction prefetch engine 14 and the instruction cache are shown as part of the processor 12, it is also possible to use another processing device or an external cache to implement the functionality discussed herein. Moreover the implementation of this functionality may be realized by using various combinations of software and hardware with close or equivalent performance. For example the invention may be implemented with a conventional processor executing instructions stored in a machine readable medium such as a CD ROM.

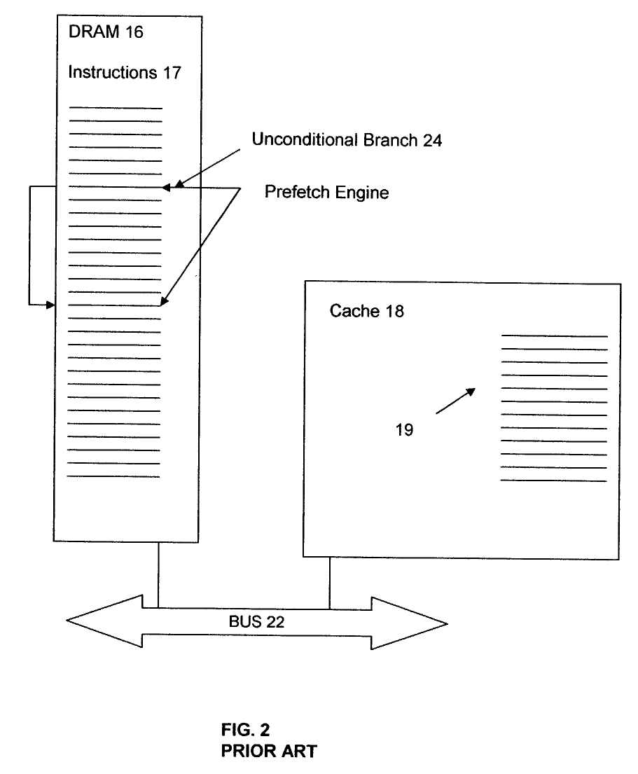

Referring to FIG. 2, when the prefetch engine 14 recognizes an operation code, or opcode (the part of a machine instruction that instructs the computer what to do, such as input, add or branch), corresponding to an unconditional branch instruction it continues to prefetch instructions at the target address of the unconditional branch instruction. The prefetch engine 14 creates a copy of the unconditional branch 24 in the faster cache 18 The execution engine 13 can then proceed to execute the instructions from the copy in the cache 18. Cache 18 may also be used to temporarily store other instructions.

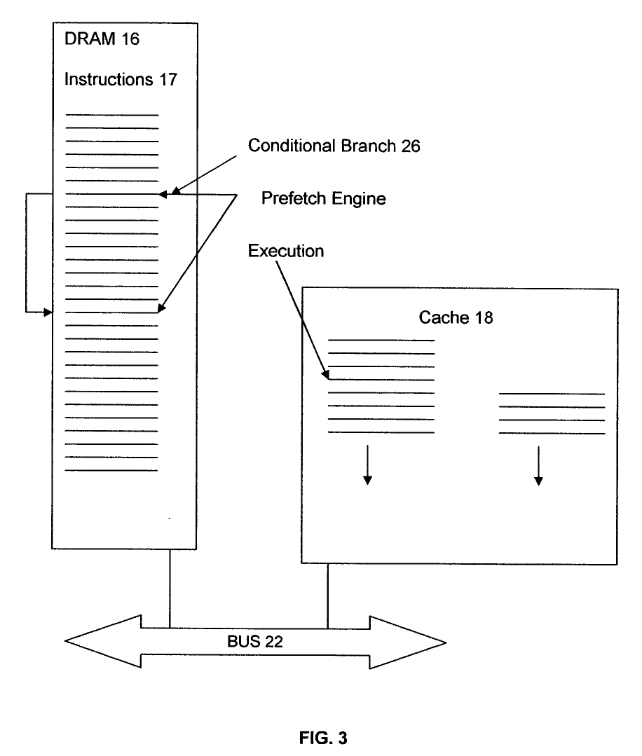

Referring to FIG. 3, the prefetch engine 14 reads instructions from the system memory 16 and when it recognizes an opcode corresponding to a conditional branch instruction 26 it prefetches instructions along each of the possible instruction branches and stores a copy of the branches in cache 18.

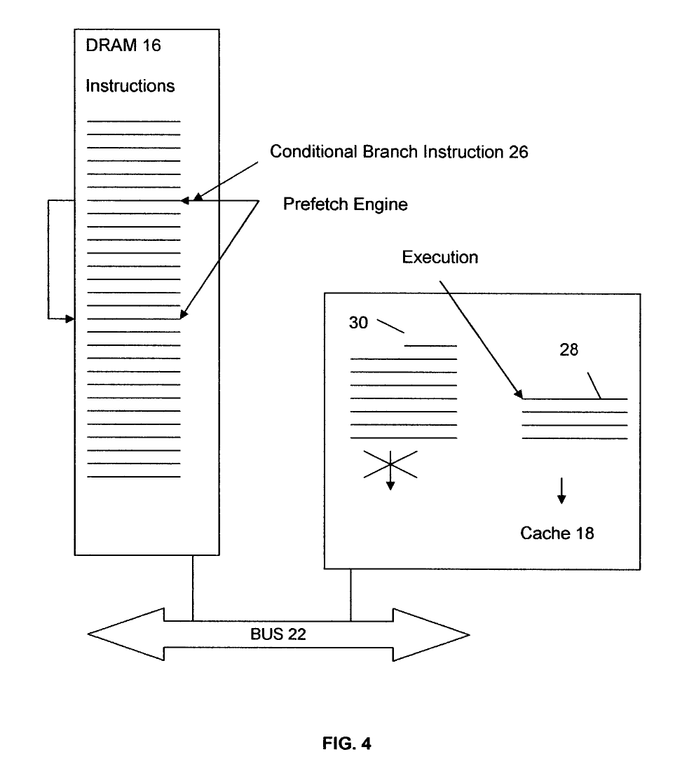

Referring to FIG. 4, when the execution engine 13 gets to the conditional branch 26 and “takes” (i.e., executes the instructions along) one branch 28 or the other then according to an aspect of the invention, the prefetch engine 14 cancels prefetching on the branch 30 (or branches) not taken.

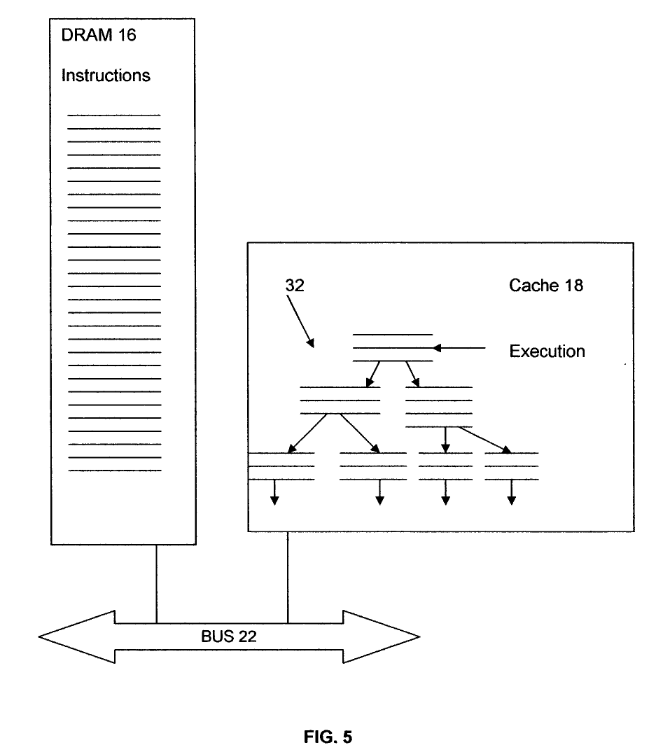

Referring to FIG. 5, depending on the “depth” of the instruction prefetch and the code being prefetched, the instruction prefetch engine 14 may encounter a conditional branch when it is already prefetching instructions along two (or more) branches. In this case the prefetched instructions would form a tree 32 and the instruction prefetch engine 14 would fetch instructions along each branch of the tree 32. There will be a point of diminishing returns and it is probably not necessary to build an instruction prefetch engine that can simultaneously prefetch instructions along each of 1024 different branches, for example. But it may be useful to allow for the possibility of prefetching on up to 8 or 16 branches, for example. Thus it may be advantageous to maintain an array of 8 or 16 prefetch queues that get reused when old branches are canceled and new conditional branch instructions are encountered.

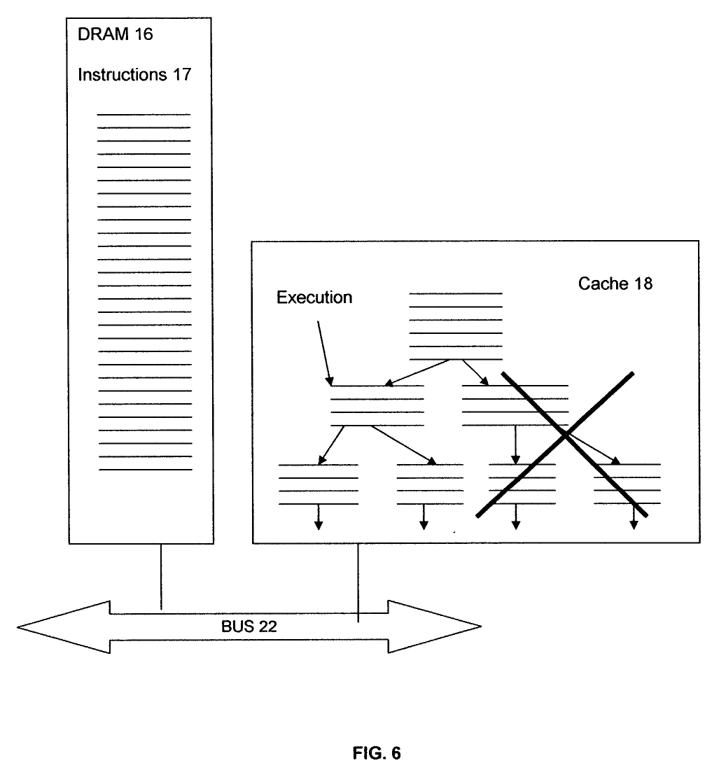

Referring to FIG. 6, when the execution unit 13 reaches a conditional branch and takes one of the branches, the prefetch engine cancels prefetching on the subtree for the branch not taken.

Since the prefetch engine may fetch instructions along multiple branches and since this could lead to memory contention problems and since it is not desired to unnecessarily slow down the execution of instructions that are making memory accesses, it is advantageous to have a priority scheme in which the processor's execution unit has a higher priority than the instruction prefetch unit in accessing memory.

The following pseudocode illustrates a possible implementation of the invention. Initially the prefetch engine is fetching along a single “live” “branch”

Do forever

For each live branch in the instruction branch tree

If there is room in the prefetch queue for this branch

Fetch instruction for this branch from this branch's
“next address”
If the instruction is not a branch or a conditional
branch

Increment this branch's “next address”

Elseif the instruction is an unconditional branch

Set “next address” for this branch = target
address of the unconditional branch

Elseif the instruction is a conditional branch

Increment this branch's “next address”
Create a new branch for the target address
Of the instruction

}

}

}

}
Create new branch (for some target address)
{

If there are no unused prefetch queues

Queue the create // it will be dequeued when another
branch is canceled

Else {

Allocate a new branch
In the parent branch, note the id of this new branch
// so when the parent branch is canceled, this branch can
//be canceled too
Set this branch's next address to the target address

}

}

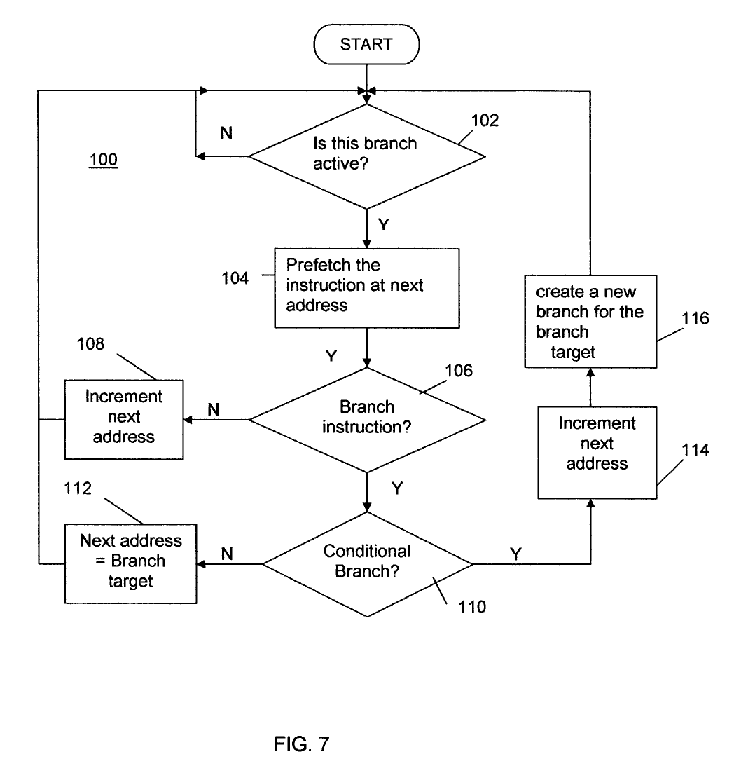

Referring to FIG. 7, there is shown a flow chart 100 illustrating at a high level, the operation of an instruction prefetch system according to an embodiment of the invention. The method comprises the following steps. In step 102, the prefetch engine determines whether a given branch is active. If it is, the prefetch engine prefetches an instruction for this branch in step 104. If not the prefetch engine doesn't do any prefetching for this branch. After the instruction is prefetched in step 104, a check is made in step 106 to determine if the instruction is a branch instruction. If not, the next address for this branch is incremented in step 108 and control returns to step 102 as shown. If the check in step 106 determines that the instruction is a branch instruction, a check is made in step 110 to determine if the branch instruction is an unconditional branch instruction or a conditional branch instruction. If step 110 determines that the instruction is an unconditional branch instruction, the next address for this branch is, in step 112, set equal to the target address of the branch instruction and control returns to step 102. If, on the other hand, the check in step 110 determines that the instruction is a conditional branch instruction, then the prefetch engine will pursue multiple paths by incrementing the next address for the current branch in step 114 and creating a new branch (or branches) for the target address (or addresses) of the branch instruction in step 116.

Other implementations are contemplated within the scope of the following claims.

We claim:

1. In an information processing system comprising an instruction execution unit, an instruction prefetch unit, a slower memory comprising instructions, and a faster memory, a method for prefetching instructions from the slower memory for storing them in the faster memory, the method comprising:
prefetching instructions from the slower memory;
recognizing a prefetched instruction, as being a conditional branch instruction;
prefetching instructions along each of the possible branches for the conditional branch instruction, responsive to recognizing the conditional branch instruction;
executing instructions from a branch from among the possible branches of the conditional branch; and
canceling prefetching of instructions from other possible branches not being executed by the execution unit.

2. The method, as set forth in claim 1, further comprising:
encountering a conditional branch instruction when already prefetching along a plurality of branches;
forming a tree of instructions; and
fetching instructions along every branch of the tree.

3. The method, as set forth in claim 2, further comprising:
reaching a conditional branch;
selecting one of the possible branches resulting from the conditional branch; and canceling prefetching on the subtree for the branch not selected.

4. The method, as set forth in claim 1, wherein the step of recognizing a prefetched instruction comprises examining the opcode for the instruction being prefetched.

5. The method, as set forth in claim 1, wherein the canceling step comprises marking a branch as non-active so that no more prefetching is done along the marked branch.

6. The method, as set forth in claim 1, wherein at least one prefetch queue is maintained, and wherein the method further comprises the first step of determining whether there is room in at least one of the prefetch queues for prefetching one or more instructions.

7. The method, as set forth in claim 6 further comprising the step of determining whether the instruction being prefetched is not a branch instruction and is not a conditional branch instruction.

8. The method, as set forth in claim 7 further comprising the step of incrementing the next address register of the current branch when it is determined that the instruction being prefetched is not a branch instruction and is not a conditional branch instruction.

9. An information processing system comprising:
a processor comprising an instruction execution unit for executing instructions and a prefetch unit for prefetching instructions;
a slower memory, coupled to the processor, for storing instructions; and
a faster memory, coupled to the processor;
wherein the prefetch unit is configured to perform the following:
prefetching instructions from the slower memory;
recognizing, a prefetched instruction as being a conditional branch instruction;
prefetching instructions along each of the possible branches for the conditional branch instruction, responsive to recognizing the opcode corresponding to the conditional branch instruction; and canceling prefetching of instructions from branches not taken by the execution unit.

10. The system of claim 9, wherein the prefetch unit is configured to:
respond to a conditional branch instruction when already prefetching along a plurality of branches;
form a tree of instructions; and
fetch instructions along every branch of the tree.

11. The system of claim 9, wherein the prefetch unit cancels prefetching on a subtree for a branch not taken.

12. The system of claim 9, wherein the execution unit includes circuitry for marking a branch not taken as non-active so that no more prefetching is done along the marked branch.

13. A machine readable medium comprising program instructions for: prefetching instructions from a slower memory for storing in a faster memory;
recognizing a prefetched instruction, as being a conditional branch instruction;
prefetching instructions along each of the possible branches for the conditional branch instruction, responsive to recognizing the conditional branch instruction;
executing instructions from a branch from among the possible branches of the conditional branch; and
canceling prefetching of instructions from other branches not being executed by the execution unit.

14. The machine readable medium of claim 13 further comprising instructions for:
responding to a conditional branch instruction when already prefetching along a plurality of branches;
forming a tree of instructions; and
fetching instructions along every branch of the tree.

15. The machine readable medium of claim 13 further comprising instructions for:
reaching a conditional branch;
selecting one of the possible branches resulting from the conditional branch; and canceling prefetching on the subtree for the branch or branches not selected.

16. The machine readable medium of claim 13 wherein the instruction of recognizing a prefetched instruction comprises examining the opcode for the instruction being prefetched.

17. The machine readable medium of claim 13 wherein the canceling instruction comprises marking a branch as non-active so that no more prefetching is done along the marked branch.

18. The machine readable medium of claim 13 wherein at least one prefetch queue is maintained, and wherein the method further comprises the first step of determining whether there is room in at least one of the prefetch queues for prefetching one or more instructions.

19. The machine readable medium of claim 13 further comprising the instruction of determining whether the instruction being prefetched is not an unconditional branch instruction and is not a conditional branch instruction.

20. An information processing device comprising:
an instruction execution unit for executing instructions; a prefetch unit for prefetching instructions; and an instruction cache for storing instructions from a slower system memory;
wherein the prefetch unit comprises circuitry for:
prefetching instructions from the slower memory;
recognizing, a prefetched instruction as being a conditional branch instruction;
prefetching instructions along each of the possible branches for the conditional branch instruction, responsive to recognizing the opcode corresponding to the conditional branch instruction; and
the execution unit comprises circuitry for canceling prefetching of instructions from branches not executed.

21. The device of claim 20, wherein the prefetch unit is comprises circuitry for:
responding to a conditional branch instruction when already prefetching along a plurality of branches;
forming a tree of instructions; and
fetching instructions along every branch of the tree.

22. The device of claim 20, wherein the execution unit comprises circuitry for canceling prefetching on a subtree for a branch not taken.

23. The device of claim 20, wherein the execution unit includes circuitry for marking a branch not taken as non-active so that no more prefetching is done along the marked branch.
